(19) United States
(12) Patent Application Publication
(10) Pub. No.: US 2004/0062844 A1
(43) Pub. Date: Apr. 1, 2004

(54) Salts of L-amino acids having improved taste and their preparation

(76) Inventors: Andreas Burgard, Frankfurt am Main (DE); Glenn Roy, Beacon, NY (US)

Correspondence Address: ProPat, L.L.C., 2912 Crosby Road, Charlotte, NC, 28211-2815, US

(21) Appl. No.: 10/664,764

(22) Filed: Sep. 17, 2003

Related U.S. Application Data
(63) Continuation of application No. 09/749,136, filed on Dec. 27, 2000, now abandoned.

(51) Int. Cl. A23L 1/236

(52) U.S. Cl. 426/548

(57) ABSTRACT

The invention relates to salts of a basic-reacting amino acid with at least one acid-reacting sweetener and to their preparation and their use.

This application is a continuation of 09/749,136 filed Dec. 27, 2000.

### FIELD OF THE INVENTION

The amino acids arginine and lysine are generally included among the essential amino acids. From nutritional aspects it can be desirable to enrich foods with these amino acids. However, for arginine especially, applications in the therapeutic sector are being discussed as well, for example for treating high blood pressure and other blood vessel disorders (EP-A 0 441 119), as a drug for diabetes mellitus (EP-A 0 370 994) and as a medicament for treating infections involving Helicobacter pylori bacteria (WO 98/57626).

The taste of this amino acid, however, is not particularly pleasant. Arginine especially is markedly bitter, which restricts its direct use in preparations for oral consumption. Therefore, to date, the taste of arginine in preparations of this type has had to be masked in a laborious manner by flavorings and, even in the case of lysine, flavor enhancement using flavorings is indicated.

DE-A 1 242 622, EP-A 0 046 506, WO-A 99/04822 and WO-A 00/12067 describe sweetener/medicament salts having improved taste, in each case the sweetener being present as anion and the medicament as monocation in a ratio 1:1. However, these applications do not describe the flavor enhancement or flavor masking of bitter-tasting amino acids. In particular, salts of dibasic amino acids, for example arginine, lysine and ornithine which are not to be considered as a medicament but rather as essential amino acids, are not described there.

### DESCRIPTION OF THE INVENTION

It has now been found that the sweetener acesulfame, which is used in the form of its potassium salt [6-methyl-3,4-dihydro-1,2,3-oxathiazine-4-one 2,2-dioxide potassium salt] to a great extent in foods, oral cosmetics and drugs, can form saltlike compounds with basic-reacting amino acids, which compounds are surprisingly no longer bitter, but have a pure sweet taste. The use of these amino acids, in particular arginine, in preparations for oral administration is thus considerably simplified.

### DETAILED DESCRIPTION OF THE INVENTION

Preparation of these saltlike compounds is simple. For example, one equivalent of L-arginine (1) is reacted in water with one equivalent of acesulfame-H (2), L-arginine acting as base and acesulfame-H as acid. Acesulfame-H is the corresponding acid to the commercially available acesulfame-K (for example Sunett®, Nutrinova, Frankfurt a.M., Germany), which can be converted to acesulfame-H by protonation by a strong acid, for example sulfuric acid. Acesulfame-H and acesulfame-K can also be synthesized by methods known from the literature (cf. EP-A 0 155 643).

The amino acids used are commercially available.

The resulting salt adduct (3) is in addition considerably more water-soluble than the non-protonated free L-arginine (1). From the resultant reaction solution the reaction product is produced in a simple manner by removing the water, for example by evaporation under reduced pressure. The L-arginine-acesulfame salt (3) is according to ¹H-NMR a 1:1 adduct.

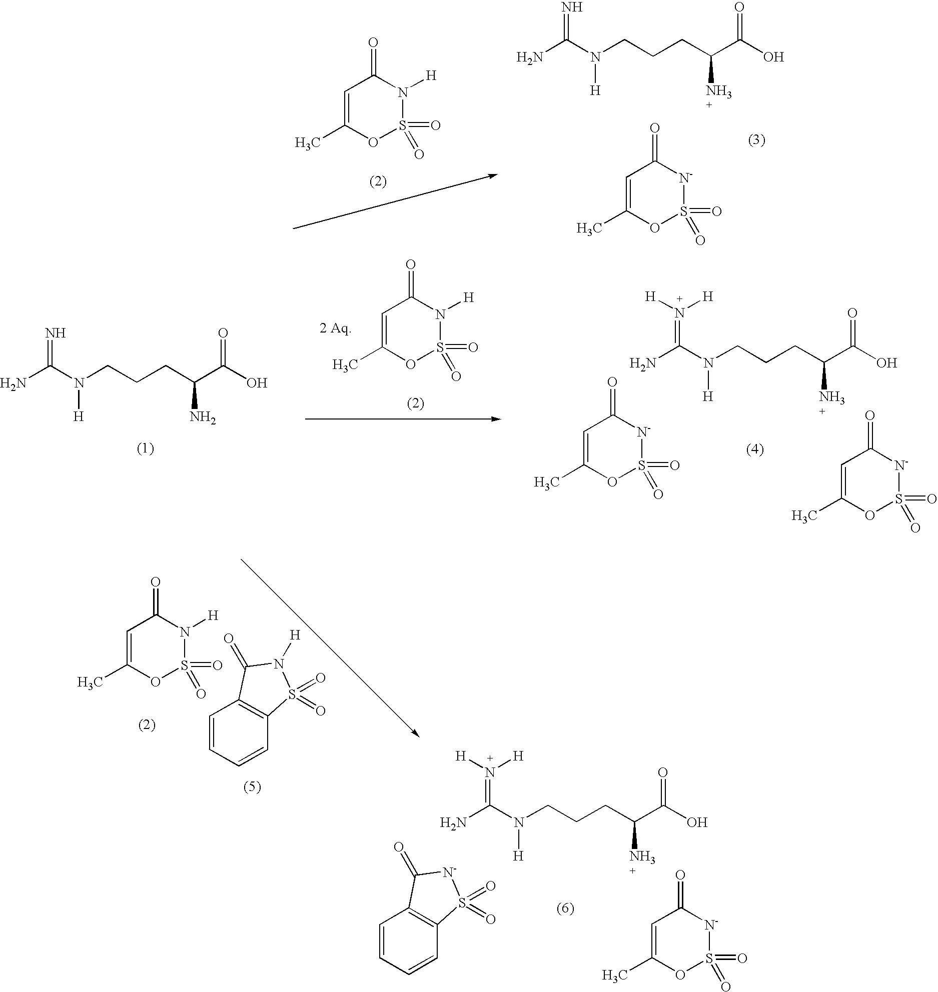

If two equivalents of acesulfame-H (2) are used as acid, there results an also stoichiometric 1:2 adduct of an L-arginine acesulfame salt (4), whose structure has been confirmed by ¹H-NMR. Both the 1:1 and the 1:2 L-arginine-acesulfame adduct have a pleasantly sweet taste without the bitter taste of L-arginine. The sweetness intensity per unit weight of the 1:2 adduct is considerably above that of the 1:1 adduct.

The reaction of L-arginine with one equivalent of acesulfame-H (2) and one equivalent of saccharin-H (5) as acid, which similarly to acesulfame-H is the corresponding acid to the commercially used sweetener saccharin sodium, gave an also sweet-tasting 1:1:1-L-arginine-acesulfame-saccharin adduct (6), which was confirmed by ¹H-NMR spectroscopy.

In the same manner, corresponding salts (adducts) with basic amino acids can be prepared with all anion-forming sweeteners, for example acesulfame, saccharin, aspartame, neotame, alitame, glycyrrhizin and gluconic acid. A multiplicity of combinations is possible here, in particular in the case of the 1:2 adducts which differ significantly from one another in their taste properties, especially in the time course of sweetness and sweetness intensity. This applies especially to adducts of one molecule of arginine and two molecules of sweetener, in which 1:2 adducts of L-arginine are prepared with the same sweetener or 1:1:1 adducts are prepared different sweeteners, of which the latter make a particularly large number of taste variants possible. The reaction of L-arginine with one equivalent of acesulfame-H and one equivalent of saccharin-H as acid gives, for example, a 1:1:1-L-arginine-acesulfame-saccharin adduct which also tastes sweet.

A variant of an abovementioned preparation of the inventive adducts is that the sweeteners are used in the form of their physiologically compatible salts and the reaction is carried out in the presence of a physiologically compatible acid which acts as a proton source. Physiologically compatible acids which can be used are, for example, hydrochloric acid, sulfuric acid, phosphoric acid, acetic acid; preferably, hydrochloric acid is used.

The method of masking the taste of basic amino acids by forming salts with anion-forming sweeteners is not restricted only to L-arginine, but can also be applied generally to other similarly-reacting amino acids, especially L-ornithine, L-histidine, L-tryptophan and L-lysine.

The abovementioned amino acid-sweetener adducts are water-soluble and can be prepared in crystalline form and incorporated as such into preparations for oral administration, for example tablets and various types of compressed preparations, chewing gum and chewing tablets. In addition they have the advantage that as salts they do not separate, which would cause taste inhomogeneities. Such separations are a known problem in the preparation of foods and drugs.

Owing to their water solubility, they are also suitable for use in liquid products, such as beverages or syrups, or for use in solid preparations for dissolution, such as beverage powders or effervescent tablets.

The invention is described by the examples below:

### EXAMPLE 1

Preparation of the 1:1-L-arginine-acesulfame Adduct

15 mmol (2.613 g) of L-arginine and 15 mmol (2.447 g) of acesulfame-H are dissolved in 20 ml of water. The reaction mixture is then concentrated under reduced pressure. Colorless crystals are produced with 100% yield, which, according to ¹H-NMR, are present as 1:1 adduct. 60 MHz ¹H-NMR (D₂O): d(ppm)=1.8 (m, 4H, CH₂-arginine), 2.15 (s, 3H, CH₃-acesulfame), 3.25 (t, J_{CH2,CH}=5 Hz, 2H, CH₂-arginine), 3.8 (t, J_{CH,CH2}=5 Hz, 1H, CH-arginine), 5.7 (s, 1H, CH-acesulfame)

### EXAMPLE 2

Preparation of the 1:2 L-arginine-acesulfame Adduct

15 mmol (2.613 g) of L-arginine and 30 mmol (4.894 g) of acesulfame-H are dissolved in 20 ml of water. The reaction mixture is then concentrated under reduced pressure. Colorless crystals are produced with 100% yield which, according to ¹H-NMR, are present as 1:2 adduct. 60 MHz ¹H-NMR (D₂O): d(ppm)=1.8 (m, 4H, CH₂-arginine), 2.15 (s, 6H, CH₃-acesulfame), 3.25 (t, J_{CH2,CH}=5 Hz, 2H, CH₂-arginine), 4.1 (t, J_{CH,CH2}=5 Hz, 1H, CH-arginine), 5.7 (s, 2H, CH-acesulfame)

### EXAMPLE 3

Preparation of the 1:1:1 L-arginine-acesulfame-saccharin Adduct

15 mmol (2.613 g) of L-arginine and 15 mmol (2.447 g) of acesulfame-H are dissolved in 20 ml of water. 15 mmol (2.748 g) of saccharin-H are then added. The reaction mixture is then concentrated under reduced pressure. Colorless crystals are produced with 100% yield which, according to ¹H-NMR, are present as 1:1:1 adduct. 60 MHz ¹H-NMR (D₂O): d(ppm)=1.8 (m, 4H, CH₂-arginine), 2.2 (s, 3H, CH₃-acesulfame), 3.35 (t, J_{CH2,CH}=5 Hz, 2H, CH₂-arginine), 4.1 (t, J_{CH,CH2}=5 Hz, 1H, CH-arginine), 5.85 (s, 1H, CH-acesulfame), 8.1 (s, 4H, H-saccharin)

What is claimed is:

1. A salt of a basic-reacting amino acid with at least one acidic-reacting sweetener.

2. A salt as claimed in claim 1, wherein the amino acid is arginine, lysine, histidine, tryptophan or ornithine.

3. A salt as claimed in claim 1, wherein the sweetener is selected from one or more of the following sweeteners: acesulfame, aspartame, alitame, cyclamate, glycyrrhizin, neotame, saccharin and gluconic acid or gluconate.

4. A salt as claimed in claim 1, wherein amino acid and sweetener are present in a molecular ratio of 1:1.

5. A salt as claimed in claim 1, wherein amino acid and sweetener are present in a molecular ratio of 1:2.

6. A salt as claimed in claim 5, wherein two different sweeteners are present in the molecule.

7. A process for preparing a compound as claimed in claim 1, which comprises either
1) reacting an amino acid in the form of its free acid with one or two identical or different sweeteners and isolating the reaction product formed, or
2) reacting an amino acid with one or two identical or different sweeteners in the form of their physiologically compatible salts in the presence of a physiologically compatible acid and isolating the reaction product formed.

8. The process as claimed in claim 7, wherein the reaction is carried out in the presence of water or with water-miscible solvent or with a mixture of water and water-miscible solvent as solvent.

9. The process as claimed in claim 7, wherein the physiologically compatible acid is hydrochloric acid, sulfuric acid, phosphoric acid or acetic acid.
